(19) United States
(12) Patent Application Publication
(10) Pub. No.: US 2009/0038711 A1
(43) Pub. Date: Feb. 12, 2009

(54) Fence Assembly for a Hand Jointer

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/834,275

(22) Filed: Aug. 6, 2007

(51) Int. Cl. B27C 5/04; B23Q 1/25; B23Q 3/00

(52) U.S. Cl. 144/253.8

(57) ABSTRACT

A hand jointer includes a fence assembly, a jointer base assembly and a jointer table assembly. The fence assembly includes a fence member made of granite and the fence member defines a fence surface for supporting a wood workpiece. A fence adjusting means is mounted to a side of the jointer table assembly and connects to the fence member. The fence adjusting means allows the fence member to tilt to adjust the angle between the fence member and the jointer table assembly.

### FIELD OF THE INVENTION

1. Field of the Invention

The present invention relates to a fence assembly designed for use on wood working machine tools such as hand jointers.

2. Description of the Related Art

A hand jointer is one of a kind of wood making machine tools. The hand jointer allows an operator to form a precise angle between two surfaces on a workpiece, usually a wood board to be used in a final product such as furniture, cabinetry, and the like.

Referring to Taiwan Pat No. 106774, a hand jointer includes a platform for allowing a wood workpiece to abut and the platform can be tilted to various different angles with respect to a table assembly on which the wood workpiece mounts. However, as the platform is made of metal, such as cast steel, the platform is susceptible to change over temperature and humidity. Thus, the precise machining of the wood workpiece is not obtained. Also, if the platform is in contact with the table assembly, the platform will abrade the table assembly, and as the platform is made of metal, the abrasion will damage the table assembly. Furthermore, the platform requires regular maintenance from time to time in order to avoid getting rusty.

The present invention is, therefore, intended to obviate or at least alleviate the problems encountered in the prior art.

### SUMMARY OF THE INVENTION

A hand jointer includes a fence assembly, a jointer base assembly and a jointer table assembly. The fence assembly includes a fence member made of granite and the fence member defines a fence surface for supporting a wood workpiece. A fence adjusting means is mounted to a side of the jointer table assembly and connects to said fence member. The fence adjusting means allows the fence member to tilt to adjust the angle between the fence member and the jointer table assembly. The fence member also defines a fence surface and two engaging slots disposed at two distal ends thereof respectively. Two fence positioning cushions are engaged into two engaging slots respectively. Each fence positioning cushion is made of resilient and flexible material, such as nylon material. Furthermore, the fence position cushion is adapted to support a wood workpiece that is too thin to be supported by said fence member.

It is an objective of the present invention that the fence member is made of granite.

It is another objective of the present invention that the fence member includes the fence positioning cushions that is adapted to prevent the fence member from abrading the jointer table assembly and to support a wood workpiece that is too thin to be supported by the fence member.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hand jointer in accordance with the present invention.

FIG. 2 is an exploded perspective view of a fence assembly in accordance with the present invention.

FIG. 3 is a partial, enlarged view of the fence assembly shown in FIG. 2.

FIG. 4 is a cross-sectional view taken along line 4-4 of FIG. 1, with a wood workpiece supported by the fence assembly.

FIG. 5 is a cross-sectional view illustrating another position of the fence assembly.

FIG. 6 is a cross-sectional view similar to FIG. 3, with a relatively thinner wood workpiece supported by the fence assembly.

### DETAILED DESCRIPTION

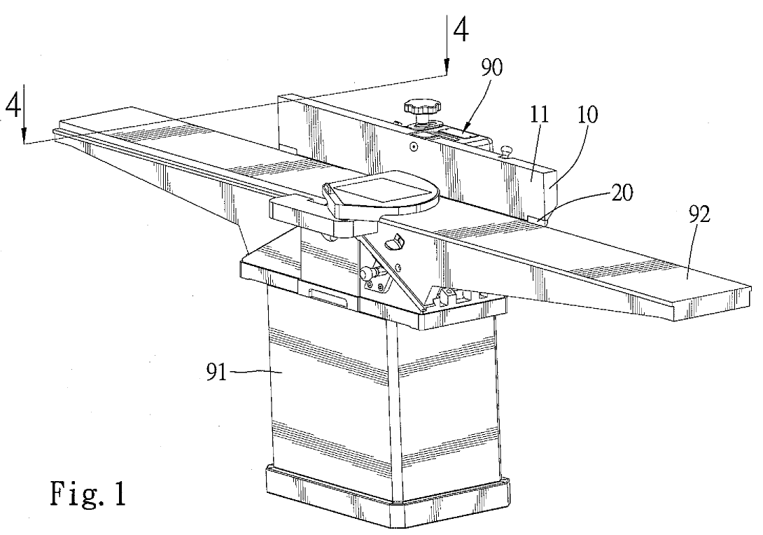

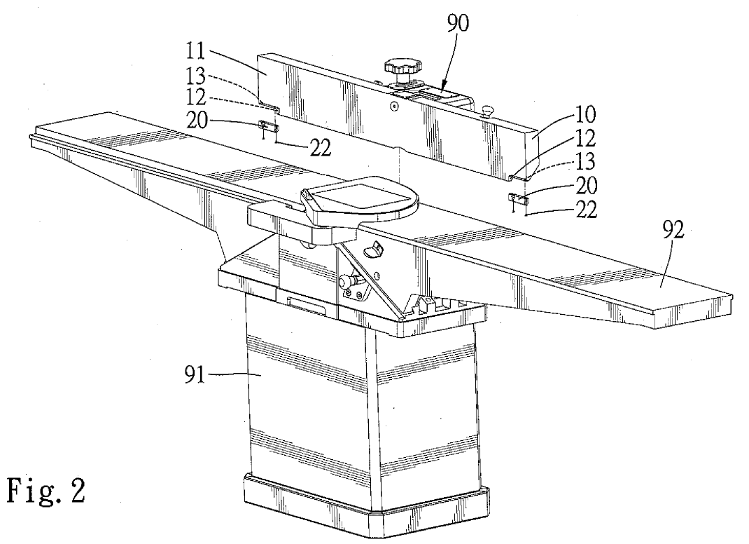

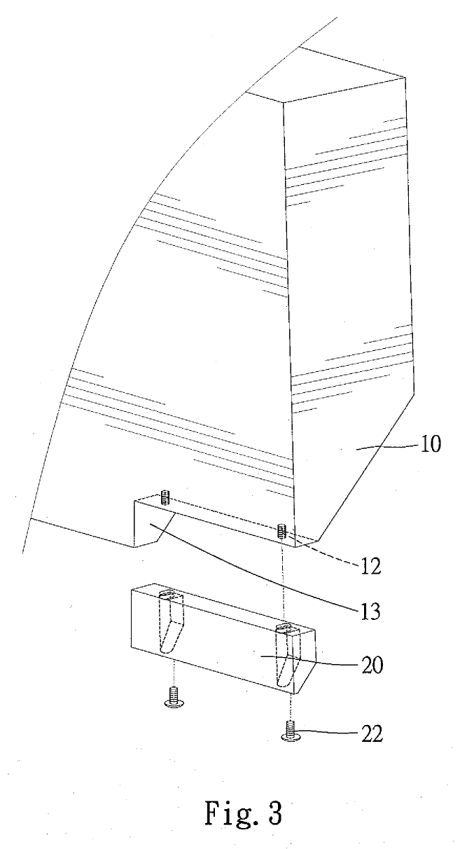

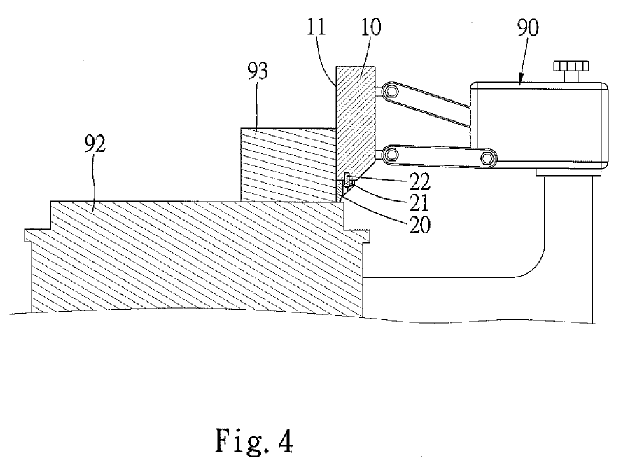

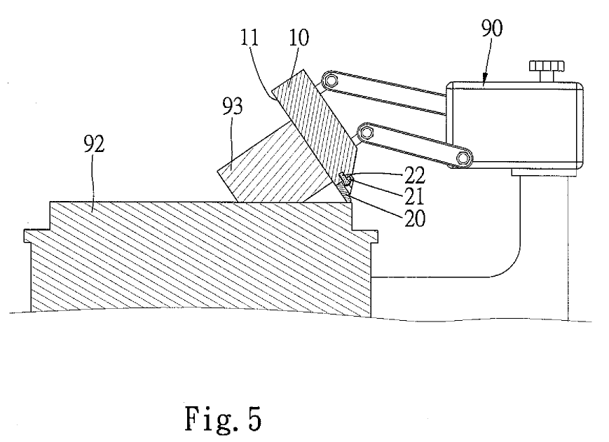

Referring to FIGS. 1 through 5, a hand jointer includes a fence assembly, a jointer base assembly 91 and a jointer table assembly 92. The fence assembly includes a fence member 10 having a quadrilateral section and is made of granite. Since the fence member 10 is made of granite, the fence member 10 is not susceptible to erosion caused by acid. Furthermore, the fence member 10 is not easily deformable when subject to pressure, as the granite can sustain at least the pressure of 2000 thousand gram per sq. of millimeter, and as the granite has hardness of 5-7 according to Moh's hardness, which is 8 times higher than steel, and 2.5 times higher than cast steel. In addition, the fence member 10 has the advantages of being resistant to magnetic force, not sticky to foreign matters, being resistant over change of temperature and humidity, and able to be maintained and cleaned easily.

A fence adjusting means 90 is connected to the fence member 10 for allowing the fence member 10 to tilt to adjust the angle with respect to the jointer table assembly 92. The fence adjusting means 90 is mounted at a side of the jointer table assembly 92. The fence adjusting means 90 and the jointer table assembly 92 are fixed onto a jointer base assembly 91. The fence member 10 defines a fence surface 11 against which a wood workpiece 93 is adapted to abut. More specifically, the wood workpiece 93 is supported by the fence surface 11 during the infeed and outfeed of the jointer table assembly 92. The fence member 10 also includes two engaging slots 12 defined at two distal ends thereof respectively. Each engaging slot 12 includes at least one, and preferably two, fixing holes 13 disposed therein. Two fence positioning cushions 20 are engaged into two engaging slots 12 respectively. Each fence positioning cushion 20 includes at least one, and preferably two, fastening holes 21 corresponding to the fixing holes 13 defined by each engaging slot 12. When each fence positioning cushion 20 is engaged into its corresponding engaging slot 12, a fastener 22 is inserted through each fastening hole 13 and corresponding fixing hole 13 to thereby fixing the fence positioning cushion 20 in the engaging slot 12 of the fence member 10.

Each fence positioning cushion 20 is made of resilient and flexible material such as nylon material. Furthermore, each fence positioning cushion 20 defines a surface aligned with the fence surface 11 and against which the wood workpiece 93 is adapted to abut. The two fence positioning cushions 20 are adapted to permit the fence member 10 to pivot with respect to the jointer table assembly 92 without contacting with the jointer table assembly 92. It will be appreciated by one skilled in the art that the jointer table assembly 92 is made of cast steel. Therefore, the fence member 10 has a greater hardness than the jointer table assembly 92. Accordingly, if the fence member 10 pivots on the jointer table assembly 92, the fence member 10 could abrade the jointer table assembly 92 seriously.

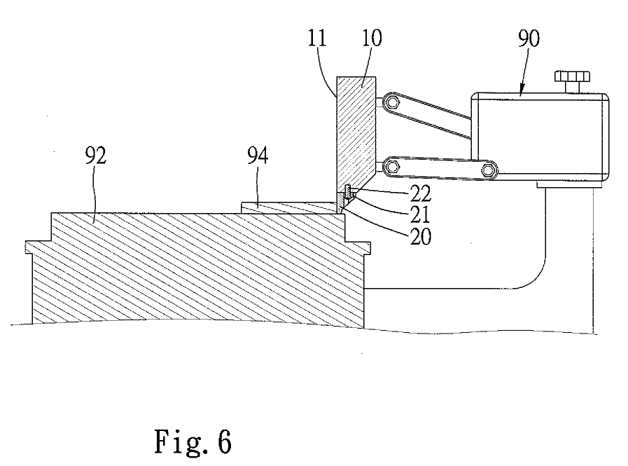

Turning to FIG. 6, a wood workpiece 94 that is too thin to be supported by the fence surface 11 is placed on the jointer table assembly 92. In this case, the wood workpiece 94 is supported by the fence positioning cushions 20. The wood workpiece 94 abuts the surface that is aligned with the fence surface 11.

In view of the forgoing, one advantage of the fence assembly for a hand jointer of the present invention is the provision of the fence member 10 that is made of granite.

Another advantage of the present invention is the provision of the fence member 10 with the fence positioning cushions 20 that is adapted to permit the fence member 10 to pivot with respect to the jointer table assembly 92 without contacting with the jointer table assembly 92, thus preventing the fence member 10 from abrading the jointer table assembly 92.

Another advantage of the present invention is the provision of the fence positioning cushions 20 that is adapted to support a wood workpiece 94 that is too thin to be supported by the fence member 10.

While the specific embodiments have been illustrated and described, numerous modifications come to mind without significantly departing from the spirit of invention and the scope of invention is only limited by the scope of accompanying claims.

What is claimed is:

1. A fence assembly for a hand jointer comprising a jointer base assembly and a jointer table assembly comprising:
a fence member made of granite and defining a fence surface allowing a wood workpiece to be supported during the infeed and outfeed of the jointer table assembly; and
a fence adjusting means adapted for allowing said fence member to tilt 8 with respect to the jointer table assembly is mounted to a side of the jointer table assembly, and with said fence adjusting means being mounted on the jointer base assembly.

2. A fence assembly for a hand jointer wherein said fence surface of the fence member defines two engaging slots disposed at two ends respectively, with each said engaging slot being receivable by a fence positioning cushion, with said fence positioning cushion made of resilient and flexible material, and with said fence positioning cushion permitting the fence member to pivot with respect to the jointer table assembly without contacting with the jointer table assembly, thus preventing the fence member from abrading the jointer table assembly.

3. A fence assembly for a hand jointer as claimed in claim 2 wherein said fence positioning cushions are made of nylon material.

4. A fence assembly for a hand jointer as claimed in claim 2 wherein each said engaging slot includes at least one fixing hole, and each said fence positioning cushions includes at least one fastening hole corresponding to said at least one fixing hole of said engaging slot, and with each said fence positioning cushion being engaged into said corresponding engaging slot by at least one fastener.

5. A fence assembly for a hand jointer as claimed in claim 2 wherein said fence position cushion defines a surface whereby a wood workpiece which is too thin to be supported by said fence surface is able to be supported, and with said surface being aligned with the fence surface.

6. A fence assembly for a hand jointer as claimed in claim 1 wherein said fence member is made of granite which has hardness greater than said jointer table assembly.
